(19) United States
(12) Patent Application Publication
(10) Pub. No.: US 2022/0113817 A1
(43) Pub. Date: Apr. 14, 2022

(54) STYLUSES FOR ELECTRONIC DEVICES

(71) Applicant: Hewlett-Packard Development Company, L.P., Spring, TX (US)

(72) Inventors: Nishit Gupta, Houston, TX (US); Dimitre D. Mehandjiysky, Spring, TX (US)

(73) Assignee: Hewlett-Packard Development Company, L.P., Spring, TX (US)

(21) Appl. No.: 17/288,547

(22) PCT Filed: Jun. 11, 2019
(86) PCT No.: PCT/US2019/036519

§ 371 Date: Apr. 25, 2021

(51) Int. Cl. G06F 3/0354; G06F 3/041; G06F 3/0485; G06F 3/0488; G06V 40/12

(52) U.S. Cl. CPC G06F 3/03546; G06F 3/04162; G06V 40/1365; G06F 3/0488; G06F 3/0485

(57) ABSTRACT

Example styluses for an electronic device are disclosed. In an example, the stylus includes a stylus body including a tip. The tip is to engage with a touch sensitive surface on the electronic device. In addition, the stylus includes a touch sensitive display on the stylus body, and a controller to control a function of the electronic device based on a touch input on the touch sensitive display.

### BACKGROUND

Styluses are pen-shaped devices that may be used to provide inputs to an electronic device. Styluses are particularly useful for providing inputs to an electronic device that has a touch sensitive display or surface. During operations, a user may grasp the stylus (e.g., like a pen or other writing instrument) and maneuver the stylus to draw or write words, images, etc., on the touch sensitive surface such that they may be displayed in an electronic format by the electronic device (e.g., on a display).

### BRIEF DESCRIPTION OF THE DRAWINGS

Various examples will be described below referring to the following figures:

FIGS. 1 and 2 are perspective views of a stylus according to some examples;

FIG. 3 is a schematic diagram of a system including the stylus of FIGS. 1 and 2 and an electronic device according to some examples;

FIGS. 4-7 are schematic views depicting different selection and control features that may be displayed on the touch sensitive display of the stylus of FIGS. 1 and 2 according to some examples; and

FIG. 8 is a schematic diagram of a system including the stylus of FIG. 1, the electronic device of FIG. 3, and an accessory device according to some examples.

### DETAILED DESCRIPTION

In the figures, certain features and components disclosed herein may be shown exaggerated in scale or in somewhat schematic form, and some details of certain elements may not be shown in the interest of clarity and conciseness. In some of the figures, in order to improve clarity and conciseness, a component or an aspect of a component may be omitted.

As previously described, styluses are devices that may be used to form words or images on a touch sensitive display or surface of an electronic device. As used herein, the term “electronic device,” refers to a device that is to carry out machine readable instructions and may include components, such as, processors, power sources, memory devices, etc. For example, an electronic device may include, among other things, a personal computer, a smart phone, a tablet computer, a laptop computer, a personal data assistant, etc. In addition, as used herein, the term “display” refers to an electronic display (e.g., a liquid crystal display (LCD), a plasma display, etc.) that is to display images generated by an associated electronic device.

Electronic devices (e.g., such as those that a stylus may be used to provide inputs for) have become increasingly more complex over time. The mode and methods of providing inputs to such electronic devices has also increased in number as well as complexity. Accordingly, examples disclosed herein include styluses for an electronic device that may be utilized to perform a writing input function for the electronic device, and may also be used to implement a host of additional inputs and control functionality for the electronic device. Thus, through use of the example styluses disclosed herein, a user may enjoy an enhanced level of control of the electronic device with the disclosed styluses.

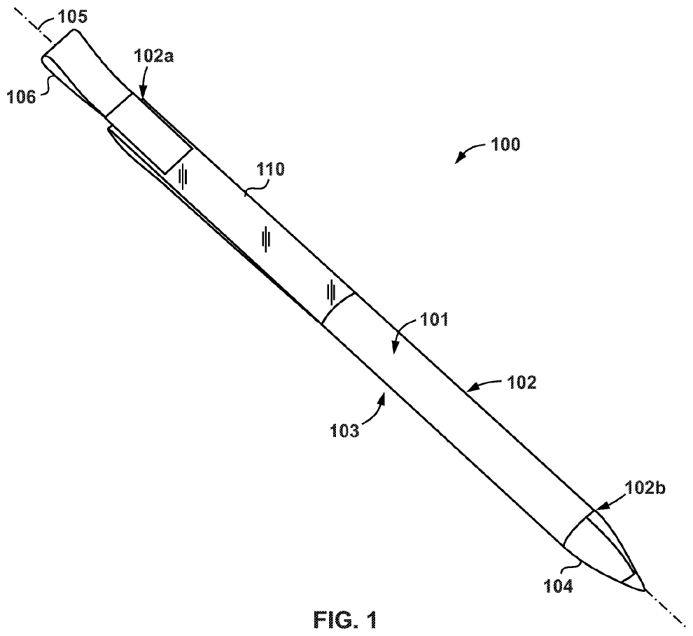

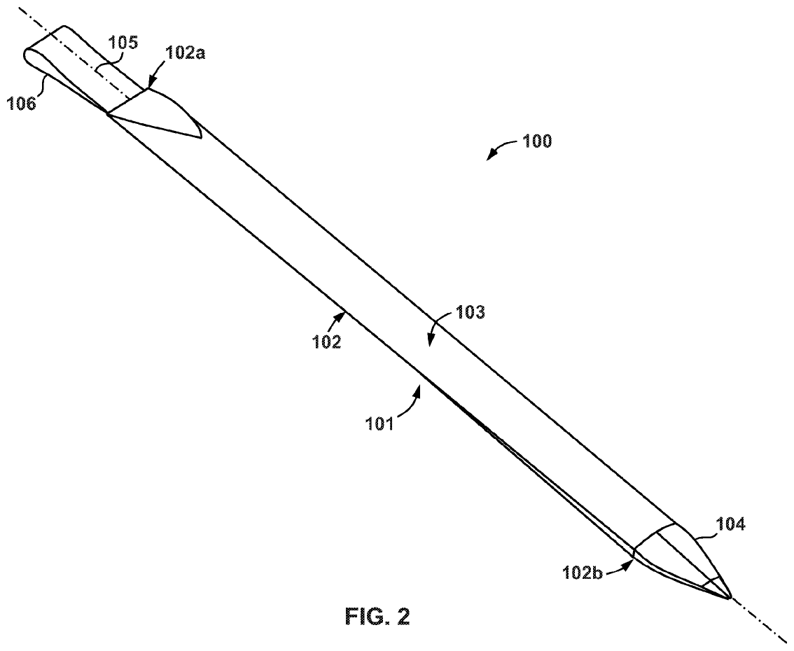

Referring now to FIGS. 1 and 2, a stylus 100 according to some examples disclosed herein is shown. Stylus 100 includes a central or longitudinal axis 105, a body 102, a tip 104, and a touch sensitive display 110 coupled to body 102.

Body 102 is an elongate member (such that it has a length greater than its width) that includes a first end 102a and a second end 102b axially opposite first end 102a. In this example, body 102 has a first side 101 extending axially between ends 102a, 102b, and a second side 103 radially opposite first side 101 that also extends axially between ends 102a, 102b. In this example, both first side 101 and second side 103 may be curved or rounded, but first side 101 has a reduced curvature compared to second side 103. In other words, a radius of curvature for first side 101 may be greater than a radius of curvature for second side 103. However, any suitable shape or cross-section may be used for body 102 in other examples. For instance, in some examples, body 102 may have a cross-section that is circular, oval, triangular, rectangular, polygonal, irregular, a combination thereof, etc.

Tip 104 is coupled to and extends axially from second end 102b of body 102. Tip 104 may engage with a touch sensitive surface of an electronic device, such as, a touch sensitive display, track pad, etc., during operations to provide input to the electronic device. In some examples, tip 104 may be readily removable from body 102 so that a user may replace tip 104 with relative ease. For instance, in some examples, tip 104 may be replaced with another tip having a different profile, and/or tip 104 may be replaced if the original tip 104 has been deformed or damaged. In some instances, tip 104 may include engagement features (e.g., snaps, projections, etc.) that engage with corresponding engagement features on body 102 (e.g., at second end 102b).

A tab 106 is coupled to and extends from first end 102a of body 102. Tab 106 may be utilized by a user to grip stylus 100 during operations. Also, in this example, tab 106 comprises a loop of material—e.g., fabric, polymer, etc. Thus, a user may attach and carry stylus 100 on a lanyard or other tether (not shown) that is extended through the loop of tab 106 during operations.

Touch sensitive display 110 may be secured to body 102 along first side 101 and proximate first end 102a. More specifically, touch sensitive display 110 may extend to first end 102a or may be more proximate first end 102a than second end 102b. Touch sensitive display 110 may utilize any suitable touch sensitive technology to detect touch inputs thereon. For instance, in some examples, touch sensitive display 110 may comprise a capacitive touch sensor, a resistive touch sensor, a surface acoustic wave touch sensor, an infrared touch sensor, a combination thereof, etc. In addition, any suitable display technology may be utilized within touch sensitive display 110 to display images, data, etc. For instance, in some examples, touch sensitive display 110 may comprise a liquid crystal display (LCD), a plasma display, organic light-emitting diode display (OLED), a combination thereof, etc.).

During operations, a user may engage a finger or other object with touch sensitive display 110 to provide input to stylus 100. As will be described in more detail below, the input to touch sensitive display 110 may then be used by stylus 100 (or a controller disposed therein) to implement changes to and/or control of a separate electronic device.

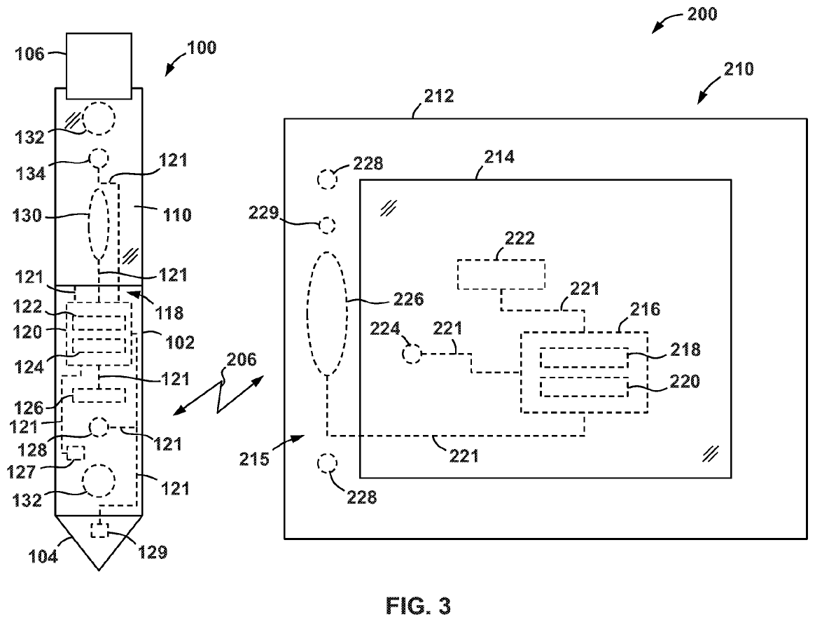

Referring now to FIG. 3, a system 200 is shown according to some examples disclosed herein. System 200 generally includes stylus 100 shown in FIGS. 1 and 2 and previously described, and an electronic device 210.

In addition to the features of stylus 100 previously described above, in some examples, stylus 100 also comprises a control assembly 118 disposed therein (e.g., within body 102). As will be described in more detail below, control assembly 118 includes a controller 120 that may be communicatively coupled to electronic device 210 during operations.

Controller 120 may comprise any suitable device or assembly which is capable of receiving signals (e.g., electrical, light, acoustic, data, etc.) and transmitting various signals (e.g., again, electrical, light, acoustic, data, etc.) to other devices (e.g., such as electronic device 210). In particular, in this example, controller 120 includes a processor 122 and a memory 124. The processor 122 (e.g., microprocessor, central processing unit, or collection of such processor devices, etc.) executes machine readable instructions provided on memory 124 to provide the processor 122 with all of the functionality described herein. The memory 124 may comprise volatile storage (e.g., random access memory), non-volatile storage (e.g., flash storage, read only memory, etc.), or combinations of both volatile and non-volatile storage. Data consumed or produced by the machine readable instructions can also be stored on memory 124.

Referring still to FIG. 3, control assembly 118 also includes a power source 126, a communication antenna 128, a wireless charging coil 130, and a proximity sensor 134 that are all coupled to controller 120. Power source 126 provides electrical power to other electronic components within stylus 100 (e.g., controller 120, antenna 128, etc.). Power source 126 may comprise any suitable source of electrical power such as, for example, a battery, capacitor, a converter or transformer, etc. In this example, power source 126 is a rechargeable battery.

Communication antenna 128 is to send and receive wireless communication signals to and from, respectively, another device or a plurality of other devices (e.g., an accessory device, electronic device 210, etc.). Communication antenna 128 may utilize any suitable wireless communication technology, such as, for example, BLUETOOTH®, WIFI, radio frequency (RF) communication, infrared communications, acoustic communications, etc. Signals sent by antenna 128 are generated in controller 120 (e.g., by processor 122) and communicated to antenna 128 such that antenna may communicate the received signals to another device (or a plurality of other devices). Conversely, signals received by antenna 128 are communicated to controller 120 such that additional actions or functions may be carried out by processor 122 in response thereto. In some examples, antenna 128 may communicate with a wireless network, such as a local WIFI connection, a telecommunications network, etc.

Charging coil 130 may comprise a coil (or multiple coils) of conductive material (e.g., wire) that is coupled (e.g., electrically coupled) to controller 120. During operations, controller 120 is to induce a flow of electrical current through coil 130, which then generates a magnetic field. If a second, corresponding coil (e.g., coil 226 in electronic device 210, described below) is placed in proximity to coil 130, this magnetic field may induce a corresponding flow of electric current in the second coil (not shown) which may then be used to charge a separate power source (not shown). In addition, if electrical current is flowed through the proximate, second coil 226, the magnetic field generated from this current may induce a corresponding flow of electrical current in the coil 130 which may then be used to charge power source 126.

Proximity sensor 134 is to sense or detect the presence of another device (or components thereof) such that controller 120 may initiate certain routines or functions. In this example, proximity sensor 134 is a magnetic sensor. In particular, proximity sensor 134 is to sense a magnetic field generated by a magnet of another device (e.g., electronic device 210). Once the strength of the magnetic field sensed by sensor 134 reaches a predetermined threshold, it may be determined (e.g., by controller 120) that the other device is within a predetermined proximity such that other functions and routines may be initiated (e.g., again, by controller 120).

The power source 126, antenna 128, coil 130, sensor 134, display 110, etc., may all be coupled to controller 120 within control assembly 118 via a plurality of conductors 121. Conductors 121 may comprise any suitable conductive conduit, path, and the like for conducting electrical, light, acoustic, or other signals therealong during operations. For instance, in some examples, conductors 121 (or some of the conductors 121) may comprise conductive wires, fiber optic lines, conductive traces, leads, etc. In addition, in some examples, some portion of the components of control assembly 118 may communicate wirelessly with controller 120.

In addition to the above described components of control assembly 118, a plurality of magnets 132 are disposed within stylus 100. In some examples, one magnet 132 is disposed within stylus 100. Magnets 132 may comprise any suitable type of magnet, such as, permanent magnets or electromagnets. In this example, magnets 132 are permanent magnets that emit a magnetic field. In other examples, magnets 132 are electromagnets that generate a magnetic field when energized with electric current, such as, for instance electric current supplied by power source 126 by controller 120. Thus, in these examples, magnets 132 may be electrically coupled to controller 120 via conductors 121.

Referring still to FIG. 3, in this example electronic device 210 is a tablet computing device (although other types of electronic devices are contemplated in other examples). Electronic device 210 includes a housing 212, and a display 214 supported within housing 212. Display 214 may be a touch sensitive display and may utilize any of the above described display technologies for touch sensitive display 110 in stylus 100.

In addition, electronic device 210 includes a control assembly 215 disposed therein. Control assembly 215 includes a controller 216, a power source 222, a wireless communication antenna 224, and a wireless charging coil 226. Controller 216 includes a processor 218 and a memory 220. The description above for controller 120 (including processor 122 and memory 124), power source 126, antenna 128, and coil 130 of control assembly 118 within stylus 100 may be applied to describe controller 216 (including processor 218 and memory 220), power source 222, antenna 224, and coil 226, respectively, of control assembly 215 within electronic device 210. As a result, a detailed description of these components within control assembly 215 is omitted herein in the interest of brevity and conciseness. In addition, while not specifically shown, in some examples, controller 216 may be coupled to display 214 such that controller 216 may receive and analyze touch inputs to display 214 during operations.

Power source 222, antenna 224, and coil 226 are coupled to controller 216 with a plurality of conductors 221. Like conductors 121 previously described above for stylus 100, conductors 221 may comprise any suitable conductive conduit, path, and the like for conducting electrical, light, or other signals therealong during operations. For instance, in some examples, conductors 221 (or some of the conductors 221) may comprise conductive wires, fiber optic lines, conductive traces, leads, etc. In addition, in some examples, some portion of the components of control assembly 215 may communicate wirelessly with controller 216.

A plurality of magnets 228, 229 are disposed within electronic device 210. As was previously described above for magnets 132 in stylus 100, magnets 228, 229 may comprise any suitable type of magnet, such as, permanent magnets or electromagnets. In this example, magnets 228, 229 are permanent magnets that emit a magnetic field. In other examples, magnets 228, 229 are electromagnets that generate a magnetic field when energized with electric current, such as, for instance electric current supplied by controller 216. Thus, in these examples, magnets 228, 229 may be electrically coupled to controller 216 via conductors 221.

During operations, a user may grasp body 102 and engage tip 104 with touch sensitive display 214 in order to provide inputs thereto. For instance, a user may utilize stylus 100 to form images, words, etc., on display 214 while electronic device is running an appropriate application or function (e.g., a word processing or drawing application).

In addition, during operations a user may form or establish a wireless connection or link 206 between stylus 100 and electronic device 210. For instance, a user may physically attach stylus 100 to housing 212 of electronic device 210 to initiate a connection routine to form wireless connection 206. Specifically, in some examples, stylus 100 may be attached to or engaged with housing 212 via attraction (e.g., magnetic attraction) between magnets 132 in stylus 100 and magnet 228 in housing 212. In addition, once stylus 100 is attached to housing 212, proximity sensor 134 in stylus 100 is placed relatively near to magnet 229 within housing 212. As a result, proximity sensor 134 may send an output signal to controller 120 (e.g., via conductor 121) indicating that stylus 100 is attached to housing 212 as described above. Thereafter, controller 120 may initiate a connection routine whereby a wireless connection or link is established between antenna 128 of stylus 100 and antenna 224 within electronic device 210. In some examples, proximity sensor 134 may sense the magnetic field generated by one of the magnets 228 instead of magnet 229 to initiate the above described connection routine. Thus, in these examples, magnet 229 is omitted from electronic device 210. In addition, in some examples, a proximity sensor (e.g., like proximity sensor 134 in stylus 100) may be included within electronic device 210. During operations, the proximity sensor in electronic device 210 may detect the presence of stylus 100 (e.g., via a magnetic field as previously described above), and then controller 216 may initiate a wireless connection routine to form or create wireless connection 206.

In some examples, a user may manually establish wireless connection 206 between stylus 100 and electronic device 210. For instance, a user may issue a command to electronic device 210 and/or stylus 100 (e.g., via touch inputs to displays 214, 110 or other buttons, switches, touch sensitive surface, etc., on electronic device 210 and stylus 100) to initiate a connection procedure (e.g., a wireless pairing procedure) to establish wireless connection 206 between antennas 128, 224 as previously described.

Further, in some examples, a user may establish a wireless connection 206 between stylus 100 and electronic device 210 by sensing a characteristic wireless signal emitted by electronic device 210 with wireless antenna 128 and/or by sensing a characteristic wireless signal emitted by stylus 100 with wireless antenna 224. Upon sensing the characteristic wireless signal (e.g., either with antenna 224 on electronic device 210 or antenna 128 on stylus 100), stylus 100 and electronic device 210 may initiate a wireless connection procedure (e.g., wireless pairing procedure) to establish wireless connection 206 between antennas 128, 224 as previously described.

Once wireless connection 206 is established between stylus 100 and electronic device 210 (e.g., via antennas 128, 224 as previously described), additional routines, functions may be carried out. For instance, electronic device 210 may initiate a wireless charging routine for power source 126 within stylus 100. Specifically, controller 216 may direct electrical current from power source 222 toward and through charging coil 226 so as to induce a flow of electricity in charging coil 130 that may then charge power source 126 within stylus 100. In some examples, controller 216 in electronic device 210 or controller 120 within stylus 100 may first determine if power source 126 is below some minimum power threshold (e.g., such as minimum charge percentage of full capacity). Controller 120 may determine the current power level of power source 126 via a conductor 121; however, controller 216 may determine the current power level of power source 126 by querying stylus 100 (particularly controller 120) via wireless connection 206 between antennas 128, 224. If controller 120 and/or controller 216 determines that power source 126 is below a first threshold (e.g., 50%, 60%, 70%, 80%, etc., of full capacity), controller 216 may then direct electrical current to charging coil 226 to charge power source 126 as previously described. These charging operations may continue until controller 120 and/or controller 216 determines that the charge of power source 126 has reached (or is above) a predetermined second threshold (e.g., 60%, 70%, 80%, 90%, 99%, 100%, etc., of full capacity) that is greater than the first threshold.

In some examples, controller 216 may continuously and constantly energize charging coil 226 such that the above described charging operations may be initiated upon placing stylus 100 (particularly coil 130) in close proximity thereto. Thus, in these examples, wireless charging of power source 126 may be initiated without first establishing wireless connection 206 between antennas 128, 224 as previously described above.

Referring still to FIG. 3, once a wireless connection 206 is established between stylus 100 and electronic device 210 (e.g., via antennas 128, 224 as previously described), user inputs to stylus 100 (e.g., via touch sensitive display 110) may initiate inputs or control commands to routines, functions, etc., carried out within electronic device 210. More specifically, a user may provide inputs to stylus 100 (e.g., via touch sensitive display 110) that are then provided to electronic device 210 (e.g., controller 216) via the wireless communications link 206 between antennas 128, 224.

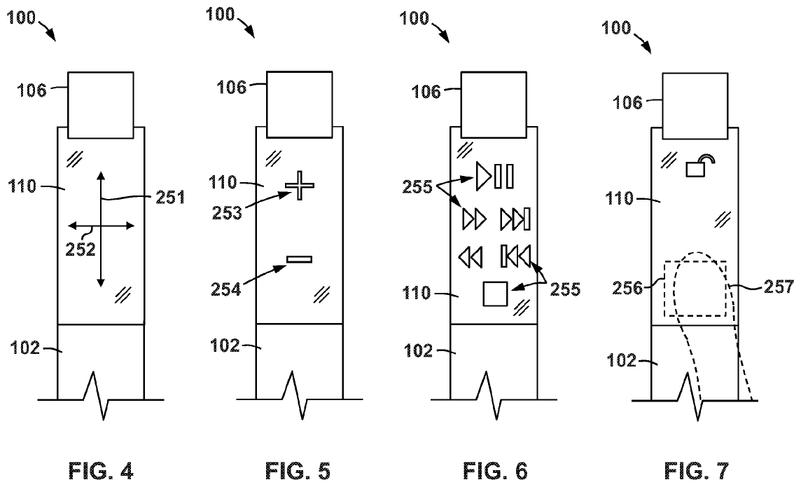

Referring now to FIGS. 3 and 4, in some examples, a user may swipe (e.g., with a finger) touch sensitive surface 110 of stylus 100 along one of a plurality of directions 251, 252 to scroll in corresponding directions within a window, document, web-page, spreadsheet, etc., displayed on display 214 of electronic device 210. In some examples, a user may simply tap a portion of touch sensitive surface 110 in locations (e.g., along the top, bottom, and sides, etc.) to issue a scroll command in the direction of the tap for a window, document, web-page, spreadsheet, etc., displayed on display 214 of electronic device 210.

Referring now to FIGS. 3 and 5, in some examples, display 110 of stylus 100 may display buttons or selection areas 253, 254 for increasing and decreasing a volume output from speakers (not shown) on (or connected to) electronic device 210. More specifically, once wireless connection 206 is established between antennas 128, 224 as previously described, a user may increase or decrease the volume of sound output from electronic device 210 (e.g., such as a volume of a video, music, sound effects, etc.) by engaging with touch sensitive display 110 on stylus 100 at the buttons 253, 254. As used herein, the term “buttons” on a touch sensitive display (e.g., such as buttons 253, 254 on touch sensitive display 110 in FIG. 5) refers to designated areas or portions on the display that a user may engage (e.g., touch) to make a designated selection or input on the touch sensitive display. In some examples, the touch sensitive display may project an image at the designated location of the “button” so as to indicate to the user where, along the touch sensitive surface of the display, that the user should engage (e.g., touch) to make the designated selection or input. Thus, in this context, a “button” on a touch sensitive display does not refer to a physical switch or other mechanical member separate from the touch sensitive display itself.

In some examples, buttons 253, 254 may be presented on display 110 when a suitable application is running on electronic device 210. In some examples, another menu may initially be present on touch sensitive display 110 that allows the user to first select a volume adjustment sub-menu (e.g., via touch input(s) on touch sensitive display 110) so as to trigger controller 120 to then display buttons 253, 254 for volume adjustment operations for electronic device 210 as previously described.

Referring now to FIGS. 3 and 6, in some examples, buttons 255 for controlling a video or sound clip (which may be generally referred to herein as a media clip) may be presented on display 110. For instance, the buttons 255 may be associated with certain functional controls of a media clip, such as, for instance, start, stop, pause, fast forward, rewind, next track, previous track, etc. As previously described for buttons 253, 254, buttons 255 may be presented on display 110 when a suitable application is running on electronic device 210 (e.g., such as a media clip). In some examples, another menu may initially be present on touch sensitive display 110 that allows the user to first select a media clip control sub-menu (e.g., via touch input(s) on touch sensitive display 110) so as to trigger controller 120 to then display buttons 255 for media clip control operations for electronic device 210 as previously described.

Referring now to FIGS. 3 and 7, in some examples, a user may supply security credentials to electronic device 210 (e.g., such as to allow the user electronic access to electronic device 210 or applications, files, or other content thereon. In some examples, the user may place a thumb 257 or other finger on touch sensitive display 110 (or a designated portion 256 of display 110) such that touch sensitive display 110 (or another component such as a biometric sensor coupled to display—such as within designated portion 256) may scan the user's fingerprint to thereby supply the requested security credentials to electronic device 210 via wireless connection 206 between antennas 128, 224. In other examples, a user may select a series of buttons or keys displayed on touch sensitive display 110 (e.g., alphanumeric keys/buttons, symbols, etc.) to provide the requested security credential (e.g., a pin number or password). In addition, in some examples, a user may provide a patterned touch (e.g., a series of swipes and/or location-specific touches) along touch sensitive display 110 to provide the requested security credential.

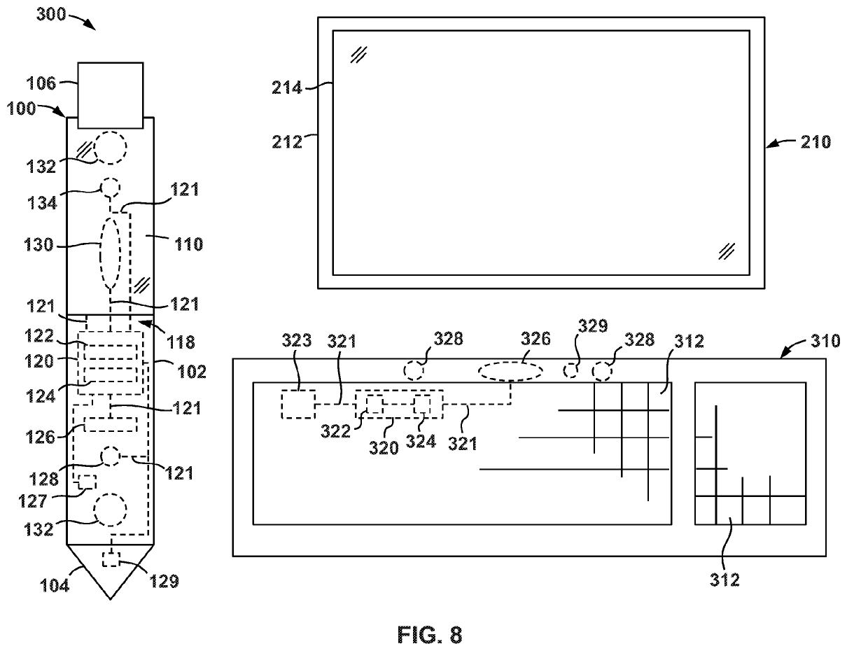

Referring now to FIG. 8, a system 300 is shown according to some examples disclosed herein. System 300 generally includes stylus 100 and electronic device 210 as previously described above. In addition, system 300 includes an additional accessory device 310. Accessory device 310 may be any suitable device for use with electronic device 210 such as, for example, a keyboard, mouse, track pad, etc. In this example, accessory device 310 is a keyboard that includes a plurality of buttons or keys 312 that a user may use to provide inputs to electronic device 210.

In addition to keys 312, in some examples, accessory device 310 may include a controller 320, which further includes a processor 322 and a memory 324. Further, in some examples, accessory device 310 also includes a power source 323, a wireless charging coil 326, and a plurality of magnets 328, 329. The description above for controller 120 (including processor 122 and memory 124), power source 126, and coil 130 of control assembly 118 within stylus 100 may be applied to describe controller 320 (including processor 322 and memory 324), power source 323, and coil 326, respectively, of accessory device 310. As a result, a detailed description of these components within accessory device 310 is omitted herein in the interest of brevity and conciseness.

Power source 323 and coil 326 are coupled to controller 320 with a plurality of conductors 321. Like conductors 121, 221 previously described above for stylus 100, electronic device 210, respectively, conductors 321 may comprise any suitable conductive conduit, path, and the like for conducting electrical, light, or other signals therealong during operations. For instance, in some examples, conductors 321 (or some of the conductors 321) may comprise conductive wires, fiber optic lines, conductive traces, leads, etc. In addition, in some examples, some portion of the components within accessory device 310 may communicate wirelessly with controller 320.

The same description above for magnets 228, 229 for electronic device 210 may be utilized to describe magnets 328, 329, respectively, disposed within accessory device 310. Thus, magnets 328, 329 may comprise any suitable type of magnet, such as permanent magnets or electromagnets. In this example, magnets 328, 329 are permanent magnets that emit a magnetic field. In other examples, magnets 328, 329 are electromagnets that generate a magnetic field when energized with electric current, such as, for instance electric current supplied from power source 323 by controller 320. Thus, in these examples, magnets 328, 329 may be electrically coupled to controller 320 via conductors 321.

During operations, stylus 100 may be magnetically attached or secured to accessory device 310 via magnetic attraction between magnets 132, 328. In addition, when stylus 100 is magnetically attached to accessory device 310 in this manner, wireless charging of power source 126 within stylus 100 may occur via charging coils 130, 326 in the manner previously described above between stylus 100 and electronic device 210 (see e.g., FIG. 3). In some examples, power source 323 may comprise a wall plug so as to facilitate the charging of stylus 100 described above.

In addition, in some examples, stylus 100 may establish a wireless connection (e.g., wireless connection 206 previously described and shown in FIG. 3) with electronic device 210 in the manner previously described above. Further, accessory device 310 may also establish a connection (e.g., a wired or wireless connection) with electronic device 210 during operation as well so as to allow a user to provide inputs or commands to electronic device 210 via stylus 100 and/or accessory device 310.

Referring again to FIG. 3, in some examples, stylus 100 may also include a motion sensor 127 (which may comprise a plurality of sensors—such as a sensor array) to measure or detect a motion of stylus 100 in space. For instance, in some examples, motion sensor 127 may include gyroscope(s), accelerometer(s), etc., to allow controller 120 to determine the motions of stylus 100. Controller 120 may communicate these measured movements to electronic device 210 via wireless connection 206 so as to improve an accuracy of touch inputs of tip 104 on touch sensitive display 214. In addition, controller 120 (or controller 216) may convert the measured motions of stylus 100 into inputs for electronic device 210. For instance, certain motions of stylus 100 (e.g., a circular motion, a straight line motion in a given direction, etc.) may be defined as commands for altering a function, process, application carried out on electronic device 210. Thus, the motions of stylus 100 measured or detected by motion sensor 127 as described above may be used to supply these commands to electronic device 210 during operations.

Referring still to FIG. 3, in some examples, a pressure sensor 129 (which may comprise a plurality of sensors) may be incorporated in, near, or adjacent to tip 104. Thus, during operations, when a user is utilizing stylus to provide inputs to touch sensitive display 214 of electronic device 210, the pressure sensor(s) may be utilized to analyze the pressure applied to display 214 and/or the angle of stylus 100 (particularly tip 104) relative to the surface of display 214 so as to alter the shape, direction, or other character of the line or points that are entered onto display 214 during these operations. Moreover, in some examples, the inputs from motion sensor 127 may further be used by controller 120 to determine the angle and movement of tip 104 relative to display 214 during these operations.

Examples disclosed have included styluses for an electronic device that may be utilized to perform a writing input function for the electronic device, and may also be used to implement a host of additional inputs and control functionality for the electronic device (e.g., stylus 100). Thus, through use of the example styluses disclosed herein, a user may enjoy an enhanced level of control of the electronic device with the disclosed styluses.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

In the discussion above and in the claims, the terms “including” and “comprising” are used in an open-ended fashion, and thus should be interpreted to mean “including, but not limited to . . . .” Also, the term “couple” or “couples” is intended to be broad enough to encompass both indirect and direct connections. Thus, if a first device couples to a second device, that connection may be through a direct connection or through an indirect connection via other devices, components, and connections. In addition, as used herein, the terms “axial” and “axially” generally refer to positions along or parallel to a central or longitudinal axis (e.g., central axis of a body or a port), while the terms “radial” and “radially” generally refer to positions located or spaced to the side of the central or longitudinal axis.

As used herein, including in the claims, the word “or” is used in an inclusive manner. For example, “A or B” means any of the following: “A” alone, “B” alone, or both “A” and “B.” In addition, when used herein including the claims, the word “generally” or “substantially” means within a range of plus or minus 10% of the stated value.

What is claimed is:

1. A stylus for an electronic device, the stylus comprising:
a stylus body including a tip, wherein the tip is to engage with a touch sensitive surface on the electronic device;
a touch sensitive display on the stylus body; and
a controller to control a function of the electronic device based on a touch input on the touch sensitive display.

2. The stylus of claim 1, wherein the controller is to supply a security credential for the electronic device.

3. The stylus of claim 2, wherein the touch sensitive display is to scan a fingerprint of a user to supply the security credential.

4. The stylus of claim 1, wherein inputs to the touch sensitive display are to control a scroll function on a display of the electronic device.

5. The stylus of claim 1, wherein the stylus body comprises a first end and a second end opposite the first end,
wherein the tip is coupled to the first end; and
wherein stylus comprises a tab coupled to and extending from the second end.

6. The stylus of claim 5, wherein the tab comprises a loop.

7. A system, comprising:
an electronic device comprising a first touch sensitive display; and
a stylus comprising:
a stylus body including a tip, wherein the tip is to engage with the first touch sensitive display;
a second touch sensitive display on the stylus body; and
a controller to control a function of the electronic device based on a touch input on the touch sensitive display.

8. The system of claim 7, wherein the controller is to supply a security credential for the electronic device.

9. The system of claim 8, wherein the second touch sensitive display is to scan a fingerprint of a user to supply the security credential.

10. The system of claim 7, wherein inputs to the second touch sensitive display are to control a scroll function on a display of the electronic device.

11. The system of claim 7, wherein the stylus body comprises a first end and a second end opposite the first end,
wherein the tip is coupled to the first end; and
wherein stylus comprises a tab coupled to and extending from the second end.

12. The system of claim 11, wherein the tab comprises a loop.

13. A stylus for an electronic device, the stylus comprising:
a stylus body including a tip, wherein the tip is to engage with a touch sensitive surface on the electronic device;
a touch sensitive display on the stylus body; and
a controller to functionally control an application on the electronic device based on a touch input on the touch sensitive display.

14. The stylus of claim 13, wherein inputs to the touch sensitive display are to:
control a scroll function on a display of the electronic device;
control the playing of a media clip played by the electronic device; or
control a volume of the electronic device.

15. The stylus of claim 14, wherein the stylus body is to engage with a housing of the electronic device via a plurality of magnets.
